(19) United States
(12) Patent Application Publication
(10) Pub. No.: US 2024/0250248 A1
(43) Pub. Date: Jul. 25, 2024

(54) LONG-LIFE LITHIUM-SULFUR BATTERIES WITH HIGH AREAL CAPACITY BASED ON COAXIAL CNTS@TIN-TIO2 SPONGE

(71) Applicant: OKINAWA INSTITUTE OF SCIENCE AND TECHNOLOGY SCHOOL CORPORATION, Kunigami Okinawa (JP)

(72) Inventors: Yabing QI, Kunigami, Okinawa (JP); Hui ZHANG, Kunigami, Okinawa (JP); Luis K. ONO, Kunigami, Okinawa (JP)

(73) Assignee: OKINAWA INSTITUTE OF SCIENCE AND TECHNOLOGY SCHOOL CORPORATION, Kunigami Okinawa (JP)

(21) Appl. No.: 18/554,200

(22) PCT Filed: Apr. 8, 2022
(86) PCT No.: PCT/US2022/024073

§ 371 Date: Oct. 6, 2023

Related U.S. Application Data
(60) Provisional application No. 63/172,253, filed on Apr. 8, 2021.

(51) Int. Cl. H01M 4/36; C01B 32/168; H01M 4/02; H01M 4/131; H01M 4/133; H01M 4/136; H01M 4/48; H01M 4/587; H01M 10/052; H01M 10/0568

(52) U.S. Cl. CPC H01M 4/366; C01B 32/168; H01M 4/131; H01M 4/133; H01M 4/136; H01M 4/48; H01M 4/587; H01M 10/052; H01M 10/0568; C01B 2202/22; C01P 2002/72; C01P 2002/85; C01P 2004/04; C01P 2004/80; C01P 2006/40; H01M 2004/021; H01M 2004/028; H01M 2300/0025

(57) ABSTRACT

A LiS battery includes a heterostructure deposited on a sponge of carbon nanotubes followed by annealing. The heterostructure may be performed by depositing layers of TiN and TiO₂, such as TiN followed by TiO₂. Following annealing, the TIN and TiO₂ may be distributed substantially uniformly in the heterostructure. In some embodiments, the TiN layer has a thickness of 10 nm and the TiO₂ layer has a thickness of 5 nm.

### BACKGROUND

Due to their high theoretical energy density (2600 Wh kg⁻¹), lithium sulfur (Li—S) batteries are considered as one of the most promising candidates to meet the ever-increasing demand of high-energy rechargeable batteries.^{[1-6]} However, the shuttling effect of lithium polysulfides that causes fast capacity fading and low Coulombic efficiency severely hinders practical applications of Li—S batteries.^{[1-3]} To address this issue, various sulfur host materials including porous nanocarbons (e.g., graphene foam and carbon nanotube network) and polar compounds (e.g., noncarbon oxides, sulfides, and nitrides) have been introduced to block the lithium polysulfides shuttling physically and chemically, respectively.^{[7-12]} Although these strategies can protect lithium polysulfides from being dissolved into the electrolyte to a certain extent, the shuttling problem of polysulfides is not completely resolved, especially under high sulfur loadings.^{[13]} Recent studies have shown that “dredging” other than “blocking” is a better solution to the problem of lithium polysulfides shuttling. The main reason is that the conversion from lithium polysulfides to Li₂S₂/Li₂S is slow during the discharging process, which will result in large accumulation of dissolved polysulfides and eventually exceed the blocking capability of sulfur hosts. To efficiently dredge lithium polysulfides, catalysts should be introduced to accelerate the conversion rate between polysulfides and Li₂S₂/Li₂S.^{[15,16]}

An ideal catalyst for lithium polysulfides conversion needs to be integrated with three important characteristics: 1) high electrical conductivity to promote electron and ion transport for the conversion reaction, 2) appropriate adsorption ability to stabilize polysulfides and 3) catalytic ability to speed up the polysulfides conversion.^{[17]} However, it is difficult to find a simple material which can simultaneously satisfy all three requirements. For example, metal oxides (such as TiO₂) show strong adsorption capability for polysulfides,^{[18,19]} but their intrinsically low electrical conductivity will impede the polysulfides from participating in the further electrochemical reactions. Similarly, although metal nitrides (such as TiN) exhibit good electrical conductivity,^{[20,21]} their weak affinities with lithium polysulfides cannot guarantee the sufficient polysulfide adsorption. Recently, heterostructures (e.g., TiN—TiO₂ and WS₂—WO₃) that combine the advantage of each component have been introduced as improved catalysts to enhance the Li—S battery performance.^{[17,22]}

### BRIEF DESCRIPTION OF THE DRAWINGS

In the figures of the accompanying drawings like reference numerals refer to similar elements.

FIG. 1 is a schematic illustration showing the fabrication process of CNTs@TiN—TiO₂ and its catalytic process for the polysulfides conversion.

FIG. 2 includes TEM images characterizing the morphology of CNTs@TiN hybrids.

FIG. 3 is a graph showing electrochemical performance of CNTs@TiN hybrids at 0.2 C.

FIG. 4 depicts the morphology and electrochemical performance of CNTs@TIN@TiO₂ at 0.2 C.

FIG. 5 includes TEM images characterizing the morphology of CNTs@TIN—TiO₂-5.

FIG. 6 illustrates an XRD pattern of CNTs@TIN—TiO₂-5.

FIG. 7 includes optical and SEM images of CNTs@TIN—TiO₂-5.

FIG. 8 includes TEM images of (a) CNTs@TIN—TiO₂-2, (b) CNTs@TIN—TiO₂-5 and (c) CNTs@TIN—TiO₂-10.

FIG. 9 includes images and graphs characterizing results of lithium polysulfide absorption tests for CNTs@TIN—TiO₂-5.

FIG. 10 includes graphs of XPS spectra of CNTs@TiN—TiO₂-5 before and after lithium polysulfides adsorption.

FIG. 11 is a graph including CV curves of CNTs@TIN—TiO₂-2, CNTs@TIN—TiO₂-5 and CNTs@TIN—TiO₂-10 symmetric cells with and without Li₂S₆ at the scan rate of 2 mV s⁻¹.

FIG. 12 includes graphs showing a process of Li₂S deposition under the potentiostatic discharge condition.

FIG. 13 includes graphs showing electrochemical performance of CNTs@TiN—TiO₂-2, CNTs@TIN—TiO₂-5 and CNTs@TIN—TiO₂-10.

FIG. 14 includes graphs showing cycling performance of CNTs@TIN—TiO₂-2, CNTs@TIN—TiO₂-5 and CNTs@TIN—TiO₂-10.

FIG. 15 includes graphs showing areal capacity performance of CNTs@TIN@TiO₂-5 at 0.2 C and 1 C.

FIG. 16 is a schematic diagram illustrating an Li—S battery incorporating CNTs@TIN—TiO₂ sponge.

### DETAILED DESCRIPTION

The complex fabrication process for manufacturing TiN—TiO₂ heterostructure catalysts makes it difficult to reasonably control and optimize the content and distribution of each component, which play a key role in the catalytic ability of the heterostructures.

The example implementations of heterostructures described herein open up new opportunities as an ideal catalyst system for lithium polysulfides conversion in a lithium-sulfur (Li—S) battery. The approaches described herein may enable control of the content and distribution of each component of the heterostructure despite the complexity of the fabrication process. In some implementations, atomic layer deposition (ALD) was utilized to hybridize the TiO₂—TiN heterostructure with a three-dimensional (3D) carbon nanotube (CNT) sponge. In some implementations, through control of the deposited thickness of TiO₂ and TiN layers and adopting an annealing post-treatment, the derived coaxial CNTs@TIN—TiO₂ sponge had improved uniformity of the TIN—TiO₂ heterostructure relative to prior approaches and improved catalytic ability. A Li—S battery incorporating the CNTs@TIN—TiO₂ according to the approach described herein achieved improved electrochemical performance with high areal capacity of 20.5 mAh cm⁻² at 15 mg cm⁻² and capacity retention of 85% after 500 cycles. Furthermore, benefiting from the highly porous structure and interconnected conductive pathways from CNT sponge, an areal capacity of up to 20.5 mAh cm⁻² can be achieved.

In some implementations, atomic layer deposition (ALD) was used to fabricate a coaxial CNTs@TiN—TiO₂ sponge based on the chemical vapor deposition (CVD)-obtained three-dimensional (3D) freestanding carbon nanotube (CNT) framework. Through controlling the thickness of TiO₂ and TiN layers at the outer surfaces of CNTs in combination with an annealing post-treatment, the coaxial CNTs@TIN—TiO₂ sponge derived from the CNTs hybrid with 10 nm of TiN wrapped by 5 nm of TiO₂ exhibited excellent ability to improve the Li—S battery performance with a high specific capacity of 1368 mAh g⁻¹ at 0.2 C and high capacity retention of 85% after 500 cycles at 1 C. A reason for the improved performance may include a more continuous interface within the TiN—TiO₂ heterostructure relative to prior approaches, which makes TiO₂ adsorb lithium polysulfides first and then readily diffuse the polysulfides to TiN to proceed with the following electrochemical catalysis. Meanwhile, with the synergistic contribution of highly conductive CNTs, TiN efficiently catalyzes the polysulfides conversion to Li₂S₂/Li₂S. Furthermore, the porous structure and interconnected conductive pathways of the 3D CNT sponge may accommodate a large amount of sulfur and guarantee its efficient utilization. As a result, the areal capacity of a Li—S battery based on the coaxial CNTs@TiN—TiO₂ sponge has been found to reach up to 20.5 mAh cm⁻², which is much higher than those of commercialized lithium ion batteries (4 mAh cm⁻²) and comparable with the recently published Li—S battery systems with the sulfur loadings higher than 8 mg cm⁻².^{[17.13.21.23.27-37]}

### Design and Manufacturing Process

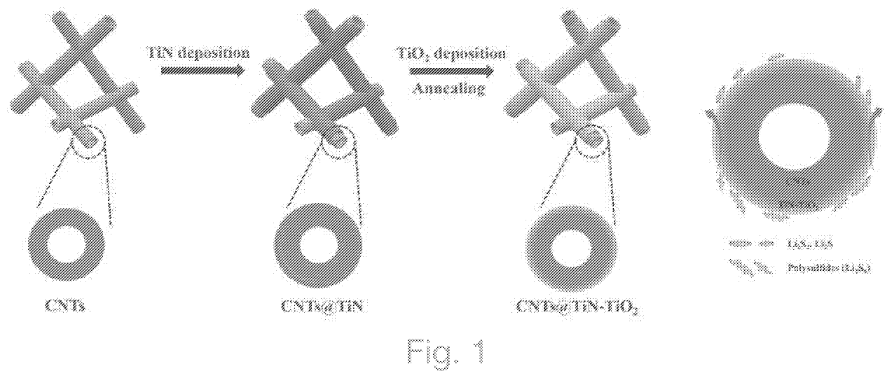

The fabrication of coaxial CNTs@TIN—TiO₂ sponge may include the following three steps: 1) depositing TiN onto CNTs following the set recipe of ALD (see the Experimental Section for the details) to obtain CNTs@TIN, 2) growing TiO₂ layer on the outer surfaces of TiN and 3) annealing the CNTs hybrid to promote the uniform distribution of TiN—TiO₂ heterostructure, as illustrated in FIG. 1. With the help of the TIN—TiO₂ heterostructure, the conversion process from lithium polysulfides to Li₂S₂/Li₂S occurs smoothly in two steps of adsorption and catalytic conversion.

The 3D porous CNT sponge may be a suitable substrate for TIN—TiO₂ deposition and characterization because of the large number and special tubular structure of multi-walled CNTs, which stack layer by layer to construct the sponge. Specifically, large amounts of CNTs (acting as substrates) guarantee abundant materials deposition. The deposited TiN (or TiO₂) can be readily identified from CNTs by transmission electron microscopy (TEM) without complex pre-treatment in planar (or micrometer-scale) substrate-based samples, which is beneficial for the structural improvements. Moreover, numerous multi-walled CNTs within the CNT sponge may interconnect with each other to provide free pathways for transporting electrons, which circumvents the electron-transport problem in thick powder-form electrodes. The CNT sponge further shows great advantage in improving the areal capacity of Li—S battery.

Different from the commonly used method of loading solid sulfur as the active material, the CNTs@TIN—TiO₂ sponge may be deposited into a lithium polysulfides solution, letting polysulfides soak into the sponge and act as the initial active materials directly. This may be the result of one or both of 1) solution infiltration being a feasible approach to load active materials into 3D sulfur hosts uniformly; 2) the matched polarity between TiO₂ (or TiN) and polysulfides facilitating the efficient stabilization of active materials, which promotes the cycling stability of Li—S battery. Benefiting from the integrated adsorption and catalytic ability of the TiN—TiO₂ heterostructure, the loaded lithium polysulfides in the CNTs@TiN—TiO₂ sponge may be stabilized on the hybridized nanotubes first and then smoothly transferred to catalytic TiN to finish the conversion reaction to Li₂S₂/Li₂S as shown in FIG. 1.

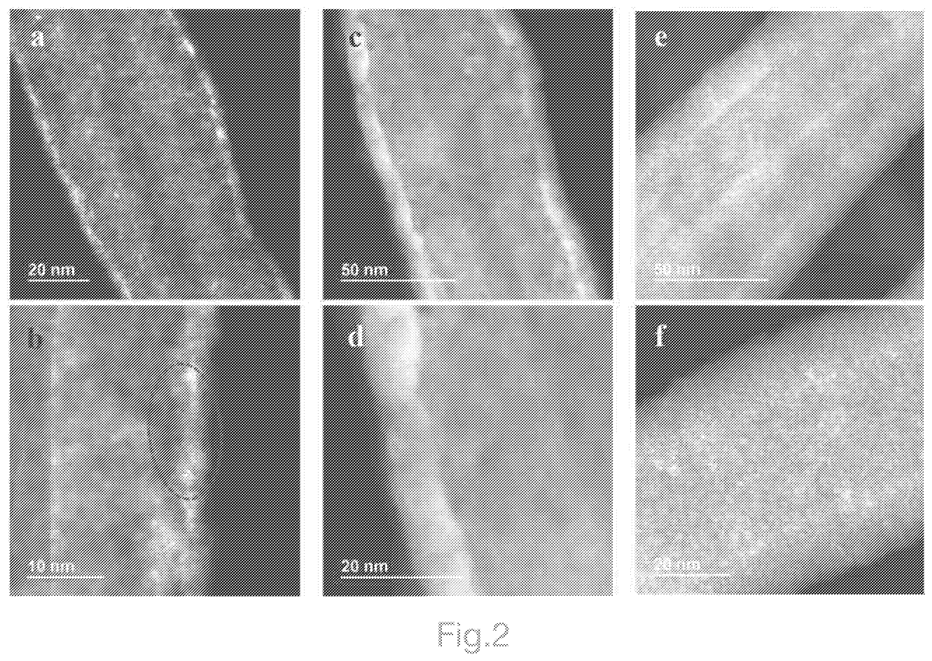

Using the atomic-scale deposition and intrinsic conformity of ALD, the TIN content can be readily controlled by the deposited thickness on CNTs. Through controlling the deposition cycles, three CNTs hybrids with three different TiN thicknesses, 5, 10 and 20 nm, were fabricated and denoted as CNTs@TIN-5, CNTs@TIN-10 and CNTs@TiN-20, respectively. FIG. 2 shows morphology characterization of CNTs@TiN hybrids. FIG. 2 includes TEM images of CNTs@TiN-5 (images (a) and (b)), CNTs@TIN-10 (images (c) and (d)), and CNTs@TiN-20 (images (e) and (f)).

From the TEM results of FIG. 2, the morphology of the CNTs@TiN hybrids, especially the interface between TiN and CNTs appears to be greatly influenced by the deposited TiN thickness. The 5 nm deposition of TiN layer on the CNT surface can be clearly identified by the low magnification TEM image (FIG. 2, image (a)). However, loose deposition on the surface of CNT with some discrete regions (FIG. 2, image (b)) is observed under high magnification condition. As the deposited thickness of TiN increases to 10 and 20 nm, the interfaces between CNTs and TiN become continuous and smooth (FIG. 2, images (c)-(f)). This morphology change may be attributed to the uneven surfaces of multi-walled CNTs, which impede the atomic deposition of TiN at some defective places, resulting in holes and bumps.

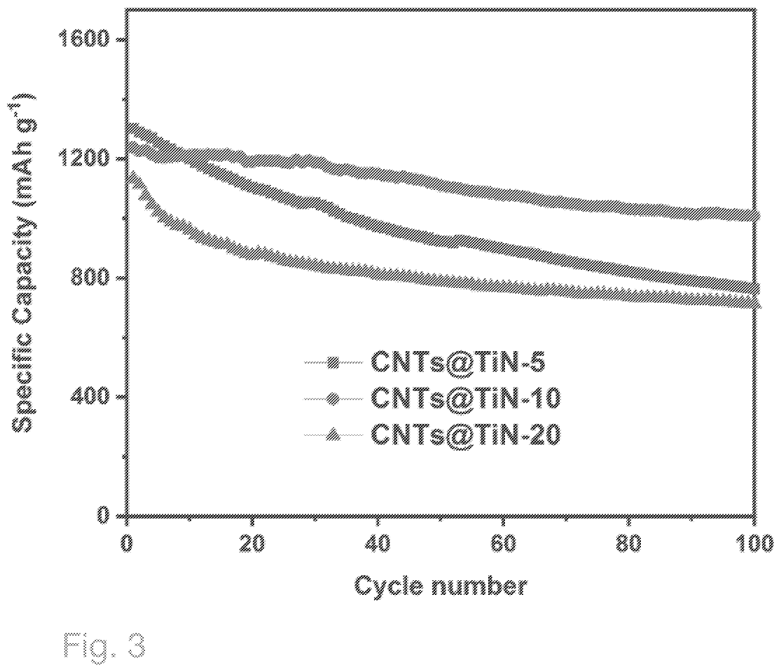

Referring to FIG. 3, to evaluate the electrochemical properties of these three hybrids, Li—S batteries using them as sulfur hosts are assembled and tested. FIG. 3 shows the electrochemical performance of CNTs@TiN hybrids at 0.2 C. Although the battery based on CNTs@TiN-5 exhibits the highest specific capacity (about 1300 mAh g⁻¹) in the first five cycles among three samples, CNTs@TiN-10 possesses the best cycling stability with over 1000 mAh g⁻¹ after 100 cycles, which is higher than 762 and 712 mAh g⁻¹ of CNTs@TIN-5 and CNTs@TiN-20, respectively. By virtue of this cycling stability, it can be concluded that the improved cycling stability is obtained within a range of thicknesses of TiN between 5 and 20 nm, such as from 7 to 13 nm, from 8 to 12 nm, or from 9 to 11 nm. CNTs@TIN-10 with a continuous TiN layer is an improved structure for the sulfur host. Although CNTs@TiN-20 has similar morphology with CNTs@TiN-10, the electric conductivity results show that the former has worse conductivity for electrons (see Table 1), which substantially limits the electrons transport and hinders the efficient utilization of polysulfides, resulting in lower specific capacity and inferior cyclic stability. In parallel, the loose and unstable structure of CNTs@TiN-5 is likely to be damaged during the repeated chemical reaction process, causing fast capacity fading.

TABLE 1
Electric conductivity test results of CNTs@TiN hybrids
by four-point probe technique.

| | | | | Average value |
|---|---|---|---|---|
| Sample | ρ1 (S m⁻¹) | ρ2 (S m⁻¹) | ρ3 (S m⁻¹) | (S m⁻¹) |
| CNTs@TiN-5 | 3.23 × 10⁵ | 3.27 × 10⁵ | 3.25 × 10⁵ | (3.25 + 0.02) × 10⁵ |
| CNTs@TiN-10 | 2.87 × 10⁵ | 2.65 × 10⁵ | 2.67 × 10⁵ | (2.73 + 0.10) × 10⁵ |
| CNTs@TiN-20 | 9.87 × 10⁴ | 9.58 × 10⁴ | 9.64 × 10⁴ | (9.70 + 0.13) × 10⁴ |

Based on the above results, CNTs@TiN-10 is regarded as a suitable structure. Hereinafter, examples are discussed with reference to CNTs@TIN-10 with the understanding that thickness of the TiN layer may be within any of the above-described ranges and still achieve at least some of the benefits of the approaches described herein.

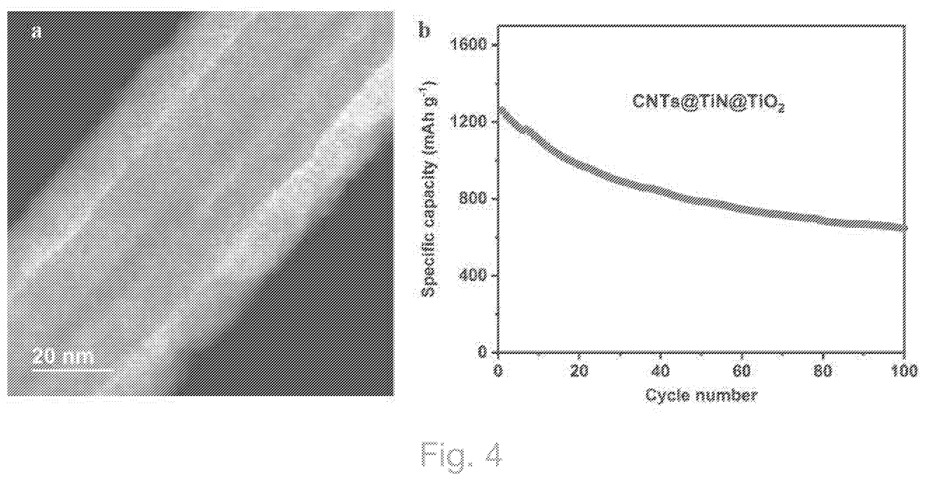

Referring to FIG. 4, CNTs@TIN-10 was applied as a new substrate for TiO₂ deposition. Subsequently, 5 nm of TiO₂ was grown on the surface of CNTs@TIN-10 by ALD method to fabricate the coaxial hybrid of CNTs@TIN@TiO₂. FIG. 4 shows the morphology and electrochemical performance of CNTs@TIN@TiO₂ at 0.2 C. As shown in FIG. 4, image (a), the inner TiN can be readily distinguished from the outer TiO₂ layer of this hybrid because TiN is much coarser and looser than TiO₂. However, the Li—S battery performance result shows that depositing TiO₂ around the CNTs@TiN severely deteriorates the battery electrochemical performance, especially for the cyclic stability (see FIG. 4, graph (b)). The dense TiO₂ layer probably blocks the diffusion of polysulfides to TiN and electron transport, which hinders the catalytic conversion of polysulfides to Li₂S₂/Li₂S.

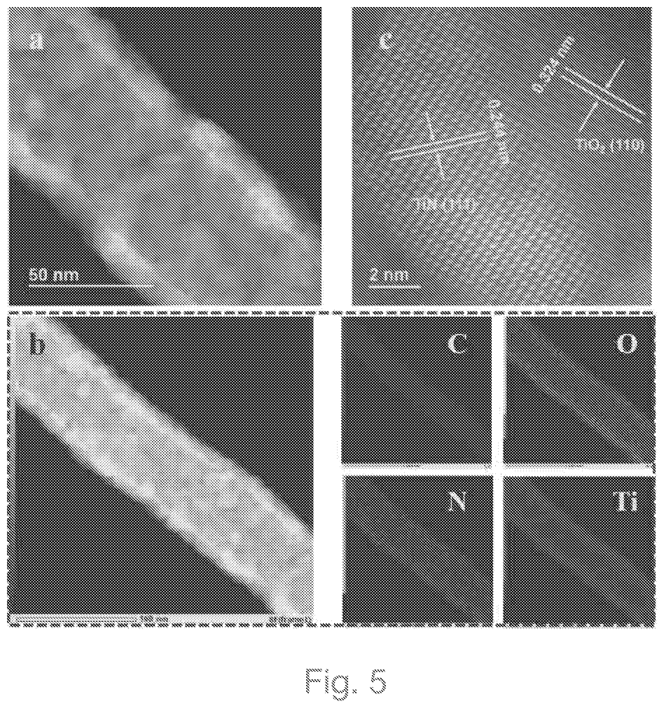

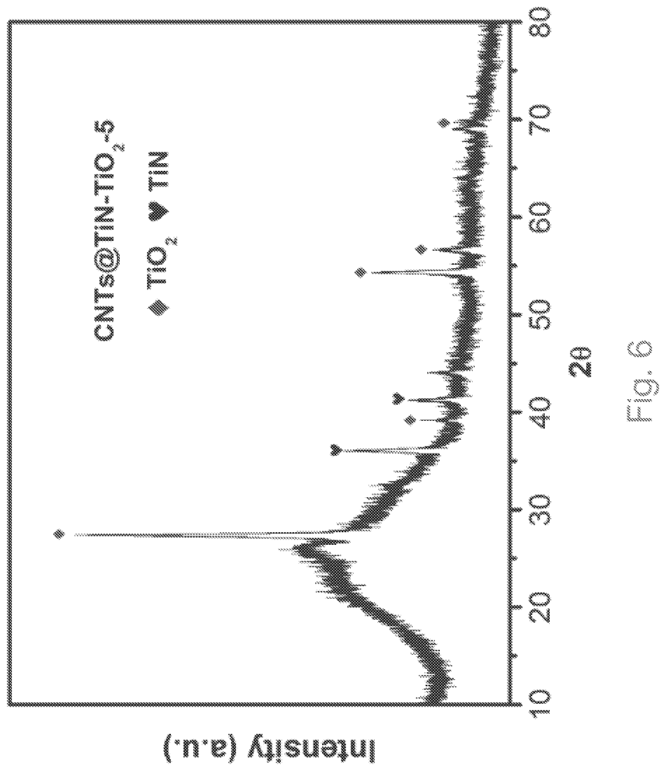

Annealing is one of the most popular post-treatment methods to improve the crystallinity and structures of the materials. To promote the favorable distribution of TiN and TiO₂, CNTs@TIN@TiO₂ may be annealed within a nitrogen (N₂) atmosphere. FIG. 5 includes TEM images showing that the TiN and TiO₂ layers are mixed to form one integrated layer coated on the CNTs after annealing without new crystalline compound formation, which is verified by the XRD pattern of the annealed product (see FIG. 6 showing the XRD pattern of CNTs@TiN—TiO₂-5). In FIG. 5, image (a) is a TEM image of CNTs@TIN—TiO₂-5 showing the integrated TiN—TiO₂ heterostructure coated on the CNTs surface. Image (b) is a TEM and corresponding elemental mappings of C, O, N and Ti in CNTs@TIN—TiO₂-5 showing the mixed and uniform distribution of TiN—TiO₂ heterostructure. Image (c) is a high-resolution TEM of CNTs@TIN—TiO₂-5 showing the well-matched interface of TiN—TiO₂ heterostructure.

The main distribution of carbon in the inner part from the corresponding EDX mapping images confirms that CNTs are applied as the original substrate for TiN and TiO₂ deposition. Interestingly, the elements of titanium, nitrogen and oxygen wrapping around the CNTs are uniformly presented. This indicates that the annealed outer layer corresponds to a mixture of TiN and TiO₂, which is well consistent with the TEM results. From the high-resolution TEM picture (FIG. 5), the lattice fringes with the spacings of 0.244 nm and 0.324 nm appear to be indexed to the (111) lattice plane of TiN and the (110) plane of TiO₂, respectively. Besides, the TiN—TiO₂ heterostructure possesses a continuous and atomically matched interface, which is beneficial for the smooth reaction process of polysulfides adsorption, diffusion and catalytic conversion.

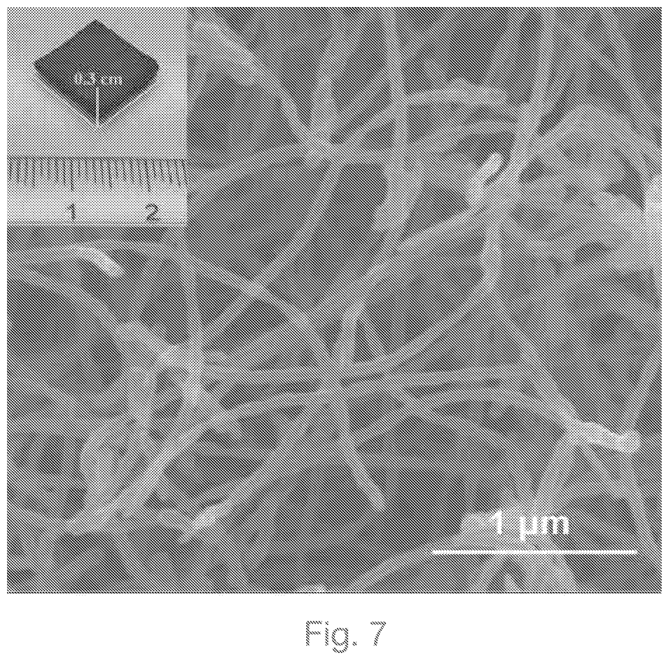

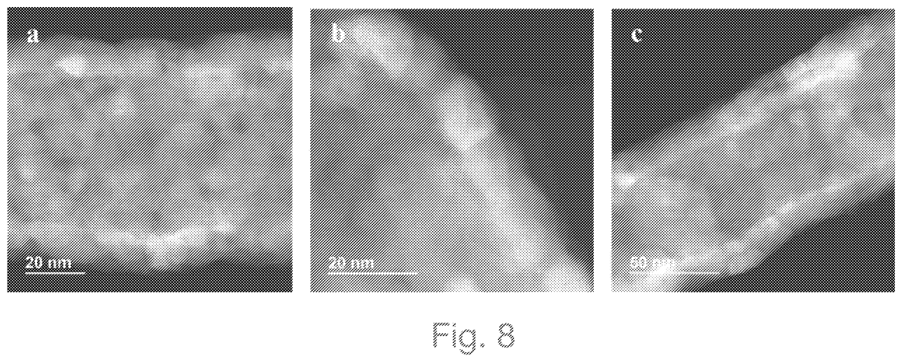

For the sake of concise description, the annealed CNTs@TIN@TiO₂ with TiN—TiO₂ heterostructure is named as CNTs@TIN—TiO₂-5, of which the number stands for the thickness of deposited TiO₂. Although the following examples make reference to CNTs@TIN—TiO₂-5, it shall be understood that a range of thicknesses of TiO₂ may be used while still achieving some of the benefit of the approach described herein, such as from 2 to 9 nm, 3 to 7 nm, 4 to 6 nm, or 4.5 to 5.5 nm. Because of the intrinsic conformity of ALD method, all TiN—TiO₂ layers may be uniformly grown around the outer surface of CNTs, and the hybridized CNTs@TIN—TiO₂-5 sponge may retain its porosity and 3D structure, which is beneficial for high sulfur loadings and efficient electrolyte permeation (see FIG. 7 showing an SEM image and photo of CNTs@TiN—TiO₂-5). To further improve the annealed TIN—TiO₂ heterostructure, two more different thicknesses of TiO₂, 2 nm and 10 nm, were deposited and annealed, which are denoted as CNTs@TiN—TiO₂-2 and CNTs@TIN—TiO₂-10, respectively. Being similar with the CNTs@TIN—TiO₂-5, CNTs@TIN—TiO₂-2 has an integrated TIN—TiO₂ heterostructure layer on the surface of CNTs (FIG. 8, TEM image (a)). TEM image (b) of FIG. 8 shows CNTs@TIN—TiO₂-5. A discontinuous and irregular boundary appears in the outer layer of the CNTs@TIN—TiO₂-10 (FIG. 8, TEM image (c)). Therefore, it can be concluded that the deposited TiO₂ thickness (i.e., TiO₂ content) is an important parameter to influence the TiN—TiO₂ heterostructure.

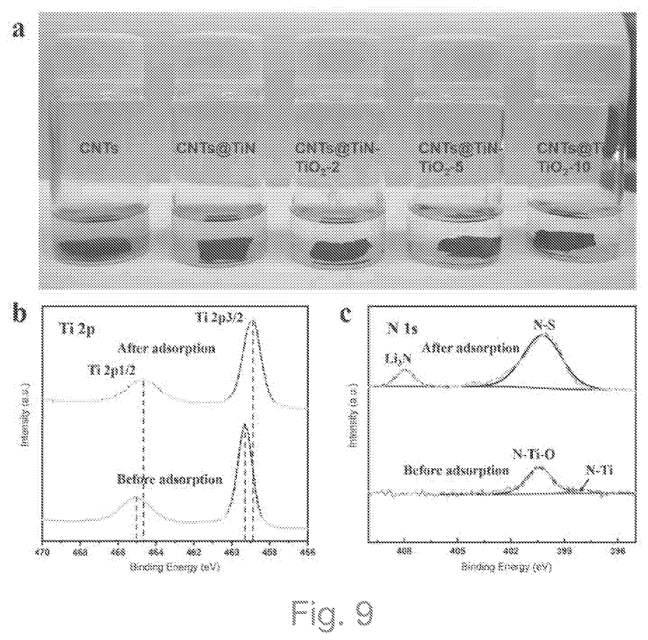

The catalytic conversion process of lithium polysulfides includes two steps of adsorption and catalytic reaction. To test the adsorption ability of CNTs@TIN—TiO₂-2, CNTs@TIN—TiO₂-5 and CNTs@TIN—TiO₂-10, these three hybrids were deposited into a Li₂S₆ solution and kept overnight (FIG. 9, image (a)). The visual test result shows that the sequence of the Li₂S₆ adsorption ability is TiO₂>TIN>CNTs, which is consistent with the previous results. Besides, with the increase of TiO₂ content, the polysulfides adsorption ability of CNTs hybrid will gradually increase. When the deposited TiO₂ thickness is 5 nm, the color of the Li₂S₆ solution becomes transparent, however, in the Li₂S₆ solution with CNTs@TiN—TiO₂-2, there are still some Li₂S₆ residues, which illustrates the limited Li₂S₆ adsorption ability of CNTs@TiN—TiO₂-2 and the importance of the TiO₂ content selection (FIG. 9, image (a)).

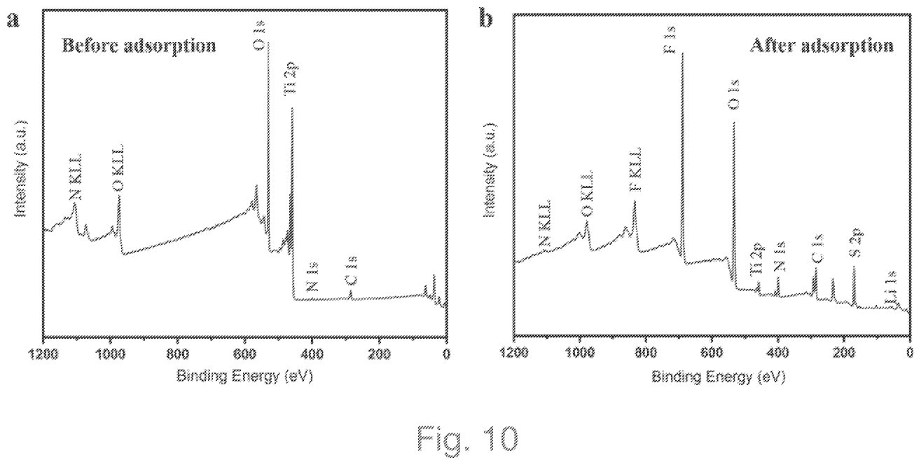

There are two main types of adsorption between the host materials and lithium polysulfides: physical adsorption and chemical adsorption. Because of the pure physical contact, the strength of physical adsorption is always too weak to stabilize polysulfides efficiently. However, relatively strong chemical interaction in the chemical adsorption has the advantage to trap lithium polysulfides, facilitating the subsequent catalytic conversion reaction. To determine the interaction between the TiN—TiO₂ heterostructure and lithium polysulfides, X-ray photoelectron spectroscopy (XPS) measurements of CNTs@TIN—TiO₂-5 before and after adsorption were conducted. Because of the immersion in Li₂S₆-contained traditional ether-based electrolyte, there is appearance of new peaks of fluorine, sulfur and lithium after adsorption (see FIG. 10 showing XPS spectra of CNTs@TIN—TiO₂-5 before and after lithium polysulfides adsorption).

FIG. 9 includes image (a), which is a comparison of polysulfides adsorption ability of CNTs@TiN—TiO₂-2, CNTs@TIN—TiO₂-5 and CNTs@TIN—TiO₂-10 by immersing these hybrids into the Li₂S₆ solution; image (b), which is an XPS spectra of (b) Ti 2p; and image (c), which shows N 1s in CNTs@TIN—TiO₂-5 before and after polysulfides adsorption. As shown in FIG. 9, image (b), two spin-orbit splitting peaks of Ti 2p (Ti 2p½ at 465 eV and Ti 2p 3/2 at 459.4 eV) shift to the positions with lower binding energy (Ti 2p½ at 464.6 eV and Ti 2p 3/2 at 458.9 eV) after Li₂S₆ adsorption, which indicates the chemical interactions between Li₂S₆ and TiN—TiO₂ heterostructure. Because of the stronger negativity of sulfur species than Ti, Ti 2p tends to accept electrons from polysulfides, resulting in lower binding energy. The formation of new peaks of Li₃N and N—S in the N 1s core-level region further demonstrates the chemical bonding of lithium polysulfides with TiN—TiO₂ heterostructure (FIG. 9, image (c)).

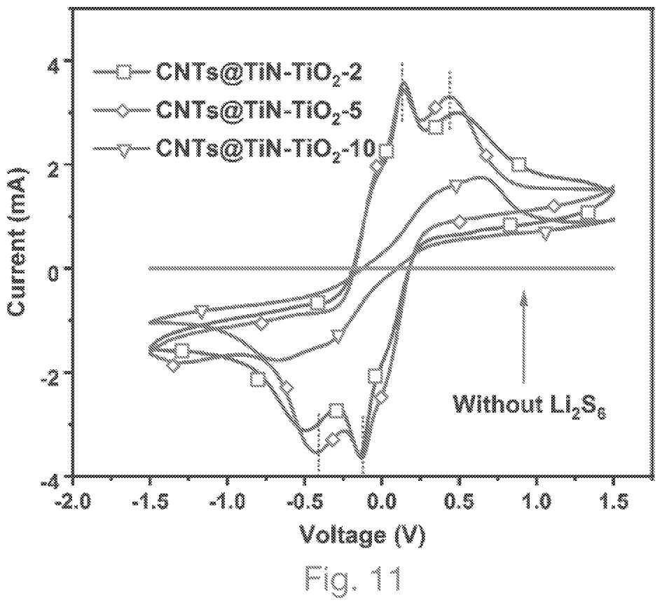

Referring to FIG. 11, a symmetric cell without the consideration of a lithium metal anode is a common configuration to evaluate the electrochemical kinetics (including the catalytic ability) of sulfur host materials. Utilizing the same material as both cathode and anode, the symmetric cells of CNTs@TIN—TiO₂-2, CNTs@TIN—TiO₂-5 and CNTs@TIN—TiO₂-10 were assembled and tested by the cyclic voltammetry (CV) method at a scanning speed of 2 mV s⁻¹. FIG. 11 shows that there is no significant or visually detectable redox peak when the electrolyte without Li₂S₆ is applied in the symmetric cells, which indicates that only Li₂S₆ is the active material to carry out the redox reactions in the testing system, excluding the influence from the commonly used ether-based electrolyte. After Li₂S₆ is added into the electrolyte, two pairs of redox peaks appear as shown in FIG. 11. Specifically, two anodic peaks correspond to the oxidation of Li₂S₂/Li₂S to lithium polysulfides and further to elemental sulfur (S₈), and two cathodic peaks are assigned to the reverse reaction process (the reduction of S₈ to polysulfides and further to Li₂S₂/Li₂S). In CNTs@TIN—TiO₂-5, these peaks exhibit narrow shapes and their separation is small, illustrating the enhanced lithium polysulfides conversion catalyzed by the TiN—TiO₂ heterostructure. In contrast, CNTs@TIN—TiO₂-2 shows broader and wider redox peaks, suggesting the inferior catalytic capability due to the limited adsorption ability for lithium polysulfides. For CNTs@TIN—TiO₂-10, not only the peaks are severely broadened and widened, the current intensity is also greatly decreased, indicating the weak catalytic activity of the TIN—TiO₂ heterostructure with irregular boundaries. These unfavorable defects hinder the diffusion of the polysulfides and therefore deteriorate the catalytic ability.

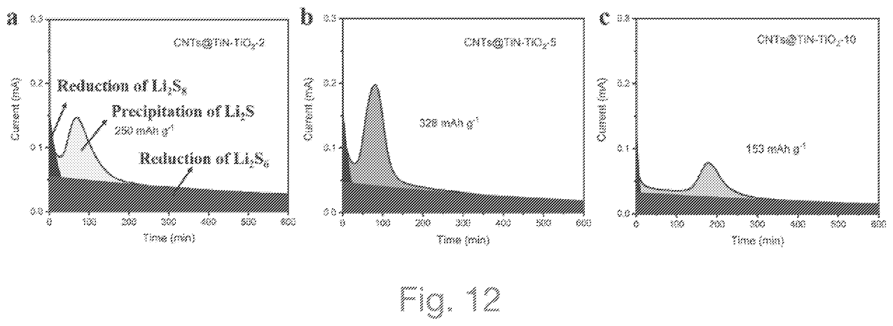

Besides, the inferior electric conductivity induced by the increased TiO₂ content limits the efficient utilization of lithium polysulfides. It is noteworthy that the Li₂S growth is an important step in the lithium polysulfides conversion process. To investigate the kinetics of Li₂S precipitation (or growth), coin cells using Li₂S₈ solution as the electrolyte were first galvanostatically discharged to 2.06 V and then potentiostatically discharged at 2.05 V until the current is lower than 10⁻⁵ mA. The precipitation current and capacity can be calculated based on the potentiostatic discharge curves as shown in FIG. 12 (see the Experimental Section for more details).

FIG. 12 shows potentiostatic discharge curves of CNTs@TIN—TiO₂-2 (image (a)), CNTs@TIN—TiO₂-5 (image (b)), and CNTs@TIN—TiO₂-10 (image (c)) at 2.05 V. CNTs@TIN—TiO₂-5 exhibits the highest current (0.2 mA) and capacity (328 mAh g⁻¹) for Li₂S precipitation compared to CNTs@TIN—TiO₂-2 (0.15 mA, 250 mAh g⁻¹) and CNTs@TIN—TiO₂-10 (0.75 mA, 153 mAh g⁻¹). These results reveal that the CNTs@TIN—TiO₂-5 possesses the best capability to accelerate the polysulfides conversion reaction (including the Li₂S precipitation) and promote the efficient utilization of lithium polysulfides.

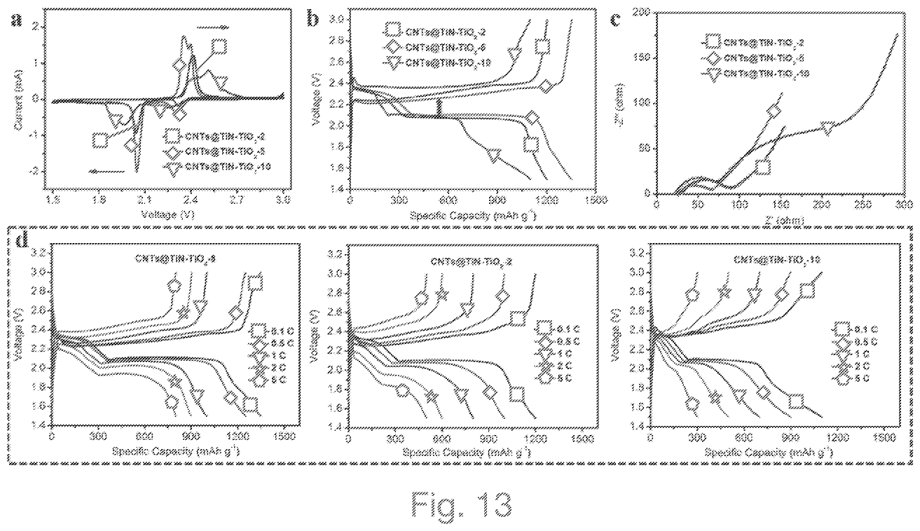

FIG. 13 shows electrochemical performance of CNTs@TIN—TiO₂-2, CNTs@TIN—TiO₂-5 and CNTs@TIN—TiO₂-10. Graph (a) includes CV curves at the scan rate of 0.1 mV s⁻¹. Graph (b) includes galvanostatic charge and discharge curves. Graph (c) includes EIS curves. Graph (d) includes rate performance from 0.1 to 5 C. The electrochemical measurements show that the Li—S battery using CNTs@TIN—TiO₂-5 as the sulfur host exhibits improved electrochemical performance relative to other thicknesses tested, including the specific capacity, rate capability and cyclic stability. From the CV results (the scan rate is 0.1 mV s⁻¹) in FIG. 13, image (a), there are two cathodic peaks during the discharge process, corresponding to the reduction of sulfur to lithium polysulfides at higher voltage and the formation of Li₂S₂/Li₂S at lower voltage, respectively. Besides, two overlapped anodic peaks during the charging process stand for the oxidation of Li₂S₂/Li₂S to lithium polysulfides and elemental sulfur. In CV curves, the separation between the corresponding cathodic and anodic peaks represents the polarization, which is correlated to the electrochemical kinetics of batteries. Theoretically, the smaller polarization reflects better electrochemical kinetics. It can be clearly observed in FIG. 13, graph (a), that CNTs@TIN—TiO₂-5 has the sharpest CV peaks, highest current intensity and smallest polarization in comparison with CNTs@TIN—TiO₂-2 and CNTs@TIN—TiO₂-10. Furthermore, CNTs@TIN—TiO₂-5 exhibits the highest discharge capacity (FIG. 13, graph (b)). In the galvanostatic charge/discharge curves, the plateaus in discharge and charge curves are attributed to the reduction and oxidation reaction processes of Li—S batteries, which agree well with the redox peaks in CV curves (FIG. 13, graph (b)). Similarly, the gap between the discharge and charge curves also stands for the polarization, of which CNTs@TIN—TiO₂-5 is the smallest among these three hybrids. Charge transfer resistance is an important indicator for the charge (e.g., electrons and lithium ions) transport during the battery working process. The electrochemical impedance spectroscopy (EIS) results show that CNTs@TIN—TiO₂-5 has the smallest semicircle diameter, which corresponds to the best charge transfer capability of the thicknesses tested and reveals the favorable electrochemical conversion reaction in the Li—S battery with CNTs@TIN—TiO₂-5 as the sulfur host (FIG. 5c). For CNTs@TIN—TiO₂-10, there are two semicircles with largely increased resistance, which illustrates that the irregular boundary in the hybrid of CNTs@TiN—TiO₂-10 can severely limit the charge transport and lithium polysulfides conversion reaction. Benefiting from the favorable electrochemical kinetics, CNTs@TIN—TiO₂-5 exhibits excellent rate performance. As shown in FIG. 5d, the specific capacities of CNTs@TIN—TiO₂-5 at the current density of 0.1, 0.5, 1, 2 and 5 C are 1350, 1250, 1000, 900 and 800 mAh g⁻¹, respectively. These values are much higher than that of CNTs@TIN—TiO₂-2 and CNTs@TIN—TiO₂-10. In addition, CNTs@TIN—TiO₂-5 possesses the smallest polarization and the change of the polarization value exhibits the gentlest increasing trend with the increase of the current density when compared to other two hybrids of CNTs@TiN—TiO₂-2 and CNTs@TIN—TiO₂-10. It further verifies that the CNTs@TIN—TiO₂-5 is a superior host material relative to the others tested to promote the polysulfides conversion and improve the electrochemical performance of Li—S batteries.

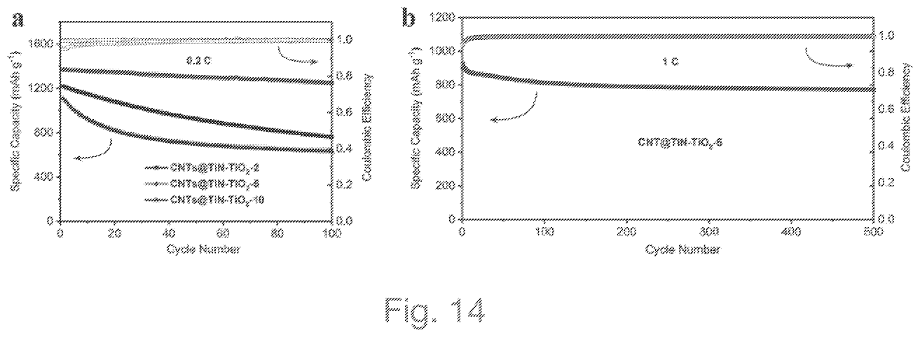

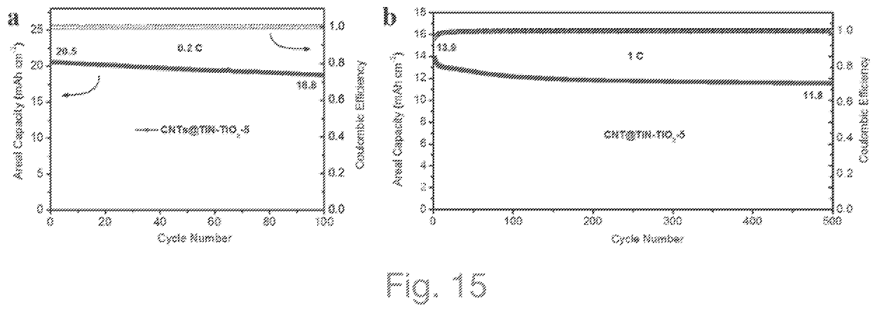

Referring to FIG. 14, the cycling performance of Li—S batteries was measured and compared. Graph (a) illustrates a cyclic stability comparison of CNTs@TIN—TiO₂-2, CNTs@TIN—TiO₂-5 and CNTs@TIN—TiO₂-10 after 100 cycles at 0.2 C. Graph (b) shows long-term cycling performance of CNTs@TIN—TiO₂-5 at 1 C. FIG. 14 shows the initial specific capacities of CNTs@TIN—TiO₂-2, CNTs@TIN—TiO₂-5 and CNTs@TIN—TiO₂-10 at the current density of 0.2 C are 1217, 1368 and 1105 mAh g⁻¹, respectively. After 100 cycles, the capacity of 1250 mAh g⁻¹ is achieved in CNTs@TiN—TiO₂-5, in contrast, only 800 mAh g⁻¹ for CNTs@TiN—TiO₂-2 and 700 mAh g⁻¹ of CNTs@TiN—TiO₂-10 are retained. As increasing the current density to 1 C, the capacity fading is kept at 0.03% per cycle after 500 cycles, which is an excellent value for the cyclic performance of Li—S battery compared to other related works (Table 2).^{[7.13.21.23.27-37]} Attributed to the 3D structure, the areal sulfur loading of CNTs@TIN—TiO₂-5 can reach up to 15 mg cm⁻², therefore, its highest corresponding areal capacity at 0.2 C is 20.5 mAh cm⁻², which is much higher than the related works focusing on Li—S battery with high areal capacity.^{[23-26]} Even at 1 C, the highest areal capacity of 13.9 mAh cm-2 can be obtained (see FIG. 15 showing areal capacity performance of CNTs@TIN@TiO₂-5 at 0.2 C and 1 C).

TABLE 2
Performance comparison among our CNTs@TiN—TiO₂-5 and other
recently reported Li—S electrodes with high areal capacity.

| | Areal capacity | | Areal capacity | | |
|---|---|---|---|---|---|
| Sulfur | (mAh · cm⁻²) | | (mAh · cm⁻²)/ | | |
| loading/ | | 100 | n^{th} cycles/ | E/S | |
| (mg · cm⁻²) | Max | cycles | C-rate | (μL · mg⁻¹) | Ref. |
| 9.8 | 10.3 | 6.86 | 6.3/350/0.2 | 7.34 | 7 |
| 21.2 | 23.3 | 17.04 | 14.8/150/0.1 | 3.53 | 13 |
| 9.6 | 12 | — | 9.96/60/0.5 | 10 | 21 |
| 12 | 11.4 | 9.73 | 7.3/200/0.1 | 6 | 23 |
| 10.2 | 9.26 | — | 8.18/70/0.2 | 4.4 | 27 |
| 19.1 | 19.3 | 9 | 9/100/0.1 | NA | 28 |
| 12 | 13.5 | — | 10.8/50/0.03 | 20 | 29 |
| 57.6 | 38.57 | 33.68 | 28.39/200/0.1 | 4.2 | 30 |
| 61.4 | 57.6 | — | 42.9/50/0.1 | 6.8 | 31 |
| 5 | 6.56 | 4.77 | 4.13/160/0.2 | NA | 32 |
| 4 | 3.60 | 2.90 | 2.9/100/0.1 | 15 | 33 |
| 3.7 | 3.40 | 3.25 | 2.6/500/0.5 | 10 | 34 |
| 18.1 | 20.00 | — | 12/70/0.2 | 5.66 | 35 |
| 5.4 | 4.00 | 3.00 | 3/100/0.02 | n/a | 36 |
| 1.5 | 2.09 | 1.29 | 0.82/300/0.2 | 30 | 37 |
| 15 | 20.5 | 18.8 | 18.8/100/0.2 | 10 | Our |
| | 13.9 | 11.8 | 11.8/500/1 | | work |

In summary, a 3D coaxial CNTs hybrid coated with TiN—TiO₂ heterostructure by ALD method combing with post-annealing has been described above. Through selection of the deposited TiO₂ thickness, an improved heterostructure with continuous interface can be obtained, which facilitates the smooth process of lithium polysulfides adsorption, diffusion and catalytic conversion. As a result, the rate performance and cyclic stability of Li—S batteries were markedly enhanced. Furthermore, attributed to the high sulfur loading of the 3D inter-connective network, high areal capacity can be achieved simultaneously. The experimental approach for selecting layer thicknesses may be used for other coaxial/layer-by-layer heterostructures and promote the formation of continuous and well-matched interfaces with promising applications in energy storage and catalysis.

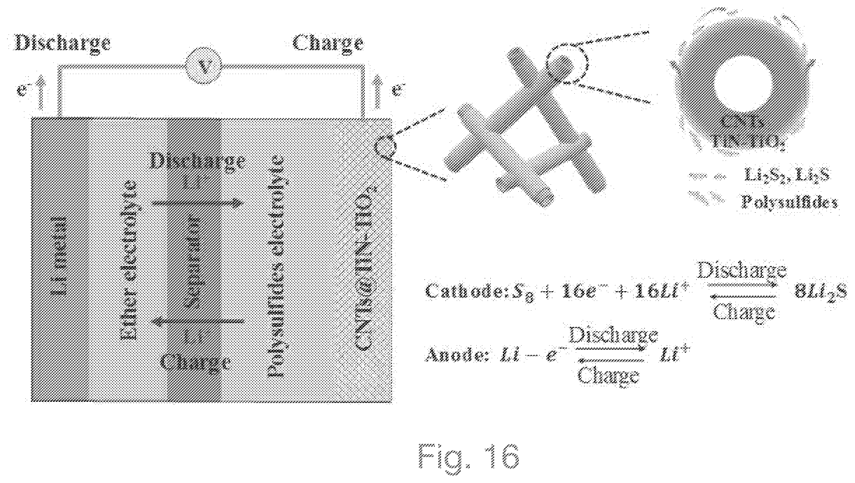

Referring to FIG. 16, an example Li—S battery incorporating the CNTs@TIN—TiO₂ heterostructure as described herein may include the following components arranged as shown in FIG. 16: an anode made of Li Metal, such as Li foil; an ether electrolyte; a separator, such as CELGARD 2400; a polysulfides electrolyte; and the CNTs@TiN—TiO₂ heterostructure.

During the discharge process of the lithium-sulfur battery, polysulfides are first adsorbed stably by TiO₂ and then smoothly catalyzed by TiN into final products of Li₂S₂/Li₂S facilitated by the continuity of the heterostructure. In the subsequent charging step, Li₂S₂/Li₂S can be reversibly oxidized to polysulfides while achieving long-term cycling stability.

### Experimental Section

Materials. Nitric acid (HNO₃, AR) was provided by Wako. Tetraglyme (99.5%), sulfur (S₈, 99.9%) and Lithium disulfide (Li₂S, 99.9%) were ordered from Sigma-Aldrich. Tetrakis(dimethylamido)titanium was bought from Japan Advanced Chemicals. All chemicals are analytical grade without further purification.

Fabrication of CNTs@TIN, CNTs@TIN@TiO₂, CNTs@TIN—TiO₂-2, CNTs@TIN—TiO₂-5 and CNTs@TIN—TiO₂-10. CNT sponge was synthesized by chemical vapor deposition method. The catalyst and carbon precursor are ferrocene and 1,2-dichlorobenzene, respectively. Before depositing TIN, CNT sponge was treated by nitric acid (70% of mass ratio) at 120° C. for 12 h, which was then washed with deionized water until neutral (pH˜7). After being freeze-dried, the CNT sponge was functionalized by carboxylic groups on the outer surfaces of CNTs, which is beneficial for the stable hybridization of sponge with other polar materials (e.g., TiN and TiO₂). CNTs@TIN and CNTs@TIN@TiO₂ were fabricated with set recipes at 150° C. by ALD method in an ALD system (Cambridge Nanotechnology Savannah S₂₀₀, see Table 3 and Table 4). The precursors for TiN and TiO₂ depositions are tetrakis(dimethylamido)titanium, and gases of NH₃ and H₂O. CNTs@TIN—TiO₂-2, CNTs@TIN—TiO₂-5 and CNTs@TIN—TiO₂-10 are the products of CNTs@TIN@TiO₂ being annealed in the furnace at a heating rate of 10° C. min-1 to 650° C. in flowing nitrogen (200 s.c.c.m). For example, a heating rate of 8 to 12° C. min-1 to a final temperature of 600 to 700° C. may yield acceptable results.

TABLE 3
Recipe of CNTs@TiN (5/10/20 nm)

| | Instruction | Number | Value |
|---|---|---|---|
| 1 | heater | 14 | 150 |
| 2 | heater | 15 | 150 |
| 3 | stabilize | 15 | / |
| 4 | stabilize | 14 | / |
| 5 | wait | / | 7200 |
| 6 | pulse | 4 | 0.15 |
| 7 | wait | / | 20 |
| 8 | pulse | 3 | 0.015 |
| 9 | wait | / | 20 |
| 10 | goto | 6 | 125/250/500 |
| 11 | flow | / | 5 |

TABLE 4
Recipe of CNTs@TiN@TiO₂ (2/5/10 nm)

| | Instruction | Number | Value |
|---|---|---|---|
| 1 | heater | 14 | 150 |
| 2 | heater | 15 | 150 |
| 3 | stabilize | 15 | / |
| 4 | stabilize | 14 | / |
| 5 | wait | / | 7200 |
| 6 | pulse | 4 | 0.15 |
| 7 | wait | / | 20 |
| 8 | pulse | 3 | 0.015 |
| 9 | wait | / | 20 |
| 10 | goto | 6 | 125/250/500 |
| 11 | flow | / | 5 |
| 12 | heater | 14 | 150 |
| 13 | heater | 15 | 150 |
| 14 | stabilize | 15 | / |
| 15 | stabilize | 14 | / |
| 16 | wait | / | 600 |
| 17 | pulse | 4 | 0.5 |
| 18 | wait | / | 10 |
| 19 | pulse | 0 | 0.03 |
| 20 | wait | / | 10 |
| 21 | goto | 17 | 40/100/200 |
| 22 | flow | / | 10 |

Fabrication of Li₂S₆ and Symmetric Cell Assembly. The Li₂S₆ electrolyte was fabricated by adding Li₂S and sulfur (molar ratio corresponds to the nominal stoichiometry of Li₂S₆) into the electrolyte with 1M lithium bis(trifluoromethane sulfonyl) imide (LiTFSI) in a mixture of 1,3-dioxolane and dimethoxyethane (1:1 in volume), and then stirring at 60° C. for 24 h. The obtained Li₂S₆-contained electrolyte (0.5 M) with the identical anodes and cathodes of CNTs@TiN—TiO₂-2, CNTs@TIN—TiO₂-5 and CNTs@TiN—TiO₂-10 were assembled into the symmetric cells for the polysulfides conversion mechanism study.

Visual Test. The electrodes of CNTs@TIN—TiO₂-2, CNTs@TIN—TiO₂-5 and CNTs@TIN—TiO₂-10 were dropped into the diluted Li₂S₆ electrolyte (0.005 M) and kept in the argon glove box overnight.

Fabrication of Li₂S₈ and Li₂S Precipitation Test. Sulfur and Li₂S in amounts of nominal stoichiometry of Li₂S₈ was mixed in tetraglyme solution at 70° C. until dark brownish-red Li₂S₈ solution was formed. The cells were assembled by applying CNTs@TiN—TiO₂-2, CNTs@TIN—TiO₂-5 and CNTs@TIN—TiO₂-10 as the cathodes, lithium foil as anode and Celgard 2500 membrane as the separator. 20 μL Li₂S₈ (0.2 M) and blank electrolyte of Li—S batteries were added on the cathode and the anode, respectively. The cells were firstly discharged with a fixed current (0.134 mA) to 2.06 V to completely transform the Li₂S₈ to Li₂S₆, which is followed by potentiostatically discharging at 2.05 V to convert Li₂S₆ to Li₂S until the current decreased to 1×10⁻⁵ mA. During the potentiostatic discharge process, time-current curves were collected to analyse the conversion from Li₂S₄ to Li₂S. According to the potentiostatic discharge curves (FIG. 4), the whole discharge process was mathematically fitted into three parts representing the reduction of Li₂S₈ and Li₂S₆ and the precipitation of Li₂S. The conversion capacity was calculated based on the areas of the precipitation of Li₂S and the weight of sulfur in Li₂S₈ electrolyte.

Material Characterization. The morphology and structure of the prepared samples were analysed by SEM (Hitachi, S-3000N) and TEM (JEOL, JEM-ARM 200F). XRD measurements were performed with a Bruker D8 Discover diffractometer (Bruker AXS, Cu X-ray source). X-ray photoelectron spectroscopy (XPS) analysis were performed on an X-ray photoelectron spectrometer (XPS-AXIS Ultra HAS, Kratos) with a monochromatic Al—Kα=1486.6 eV X-ray source. Electric conductivities of CNTs@TIN—TiO₂-2, CNTs@TIN—TiO₂-5 and CNTs@TIN—TiO₂-10 were measured using the four-point probe method on a Four-Point Resistivity Probing Equipment (Lucas Labs S-302-4).

Li—S Battery Assembly and Electrochemical Characterization. The obtained CNTs@TIN—TiO₂-2, CNTs@TIN—TiO₂-5 and CNTs@TIN—TiO₂-10 with Li₂S₆ electrolyte (1.2 M) were used as freestanding sulfur cathodes with lithium metal foils as anodes and polypropylene (PP) films (CELGARD 2400) as the separators (see FIG. 16). The 1,3-dioxolane and dimethoxyethane (1:1 volume) solution containing 1 M LiTFSI and 1 wt % lithium nitrate was applied as the electrolyte. Coin-type (CR 2032) cells were assembled in an argon-filled glove box adding 150 μL electrolyte in total, which corresponds to the average electrolyte to sulfur mass ratio of 10 μL mg⁻¹ and the average sulfur loading is 15 mg cm⁻². The equation of Ca=Cg×Ma was used to calculate the areal capacity of coin cells, where Ca, Cg and Ma stand for areal capacity, specific capacity and areal sulfur loading, respectively. A galvanostatic electrochemical test of the assembled cells was carried out on a Neware system in the potential range of 1.5-3.0 V at different discharge/charge current densities of 0.1 to 5 C. CV and EIS measurements were performed on a Metrohm Autolab electrochemical workstation. EIS curves were obtained by applying a sine wave with amplitude of 5 mV over the frequency range from 100 kHz to 0.01 Hz.

### REFERENCES

The following references are hereby incorporated herein in their entirety for all purposes: Hui Zhang, Luis K. Ono, Guoqing Tong, Yuqiang Liu, Yabing Qi*, “Long-life lithium-sulfur batteries with high areal capacity based on coaxial CNTs@TiN—TiO₂ sponge” Nat. Commun. 12, 4738 (2021); https://doi.org/10.1038/s41467-021-24976-y
[1]. P. G. Bruce, S. A. Freunberger, L. J. Hardwick, J. M. Tarascon, Li—O₂ and Li—S batteries with high energy storage. Nat. Mater. 2012, 11, 19.
[2]. A. Manthiram, Y. Fu, S.- H. Chung, C. Zu, Y.- S. Su, Rechargeable lithium-sulfur batteries. Chem. Rev. 2014, 114, 11751.
[3]. Rober F. Service, Lithium-sulfur batteries poised for leap. Science 2018, 359, 1080.
[4]. X. Fu, L. Scudiero, W. Zhong, A robust and ion-conductive protein-based binder enabling strong polysulfide anchoring for high-energy lithium-sulfur batteries. J. Mater. Chem. A 2019, 7, 1835.
[5]. T. Kim, W. Song, D. Y. Son, L. K. Ono, Y. B. Qi, Lithium-ion batteries: outlook on present, future, and hybridized technologies. J. Mater. Chem. A 2019, 7, 2942.
[6]. X. Fu, C. Li, Y. Wang, L. Scudiero, J. Liu, W. Zhong, Self-assembled protein nanofilter for trapping polysulfides and promoting Lit transport in lithium-sulfur batteries. J. Phys. Chem. Lett 2018, 9, 2450.
[7]. G. Hu, C. Xu, Z. Sun, S. Wang, H.- M. Cheng, F. Li, W. Ren, 3D graphene-foam-reduced-graphene-oxide hybrid nested hierarchical networks for high-performance Li—S batteries. Adv. Mater. 2016, 28, 1603.
[8]. X. Pu, G. Yang, C. Yu, Liquid-type cathode enabled by 3D sponge-like carbon nanotubes for high energy density and long cycling life of Li—S batteries. Adv. Mater. 2014, 26, 7456
[9]. M. D. Patel, E. Cha, C. Kang, B. Gwalani, W. Choi, High performance rechargeable Li—S batteries using binder-free large sulfur-loaded three-dimensional carbon nanotubes. Carbon 2017, 118, 120.
[10]. X. Liang, C. Hart, Q. Pang, A. Garsuch, T. Weiss, L. F. Nazar, A highly efficient polysulfide mediator for lithium-sulfur batteries. Nat. Commun. 2015, 6, 5682.
[11]. H. Lin, L. Yang, X. Jiang, G. Li, T. Zhang, Q. Yao, G. W. Zheng, J. Y. Lee, Electrocatalysis of polysulfide conversion by sulfur-deficient MoS₂ nanoflakes for lithium-sulfur batteries. Energy Environ. Sci. 2017, 10, 1476.
[12]. Z. Sun, J. Zhang, L. Yin, G. Hu, R. Fang, H. M. Cheng, F. Li, Conductive porous vanadium nitride/graphene composite as chemical anchor of polysulfides for lithium-sulfur batteries. Nat. Commun. 2017, 8, 14627.
[13]. R. Fang, S. Zhao, P. Hou, M. Cheng, S. Wang, H. -M. Cheng, C. Liu, F. Li, 3D interconnected electrode materials with ultrahigh areal sulfur loading for Li—S batteries. Adv. Mater. 2016, 28, 3374.
[14]. D. Liu, C. Zhang, G. Zhou, W. Lv, G. Ling, L. Zhi, Q. H. Yang, Catalytic effects in lithium-sulfur batteries: promoted sulfur transformation and reduced shuttle effect. Adv. Sci. 2018, 5, 1700270.
[15]. J. Park, B. C. Yu, J. S. Park, J. W. Choi, C. Kim, Y. E. Sung, J. B. Goodenough, Tungsten disulfide catalysts supported on a carbon cloth interlayer for high performance Li—S battery. Adv. Energy Mater. 2017, 7, 1602567.
[16]. G. Zhou, H. Tian, Y. Jin, X. Tao, B, Liu, R. Zhang, Z. W. She, D. Zhuo, Y. Liu, J. Sun, C. Zu, D. S. Wu, Q. Zhang, Y. Cui. Catalytic oxidation of Li₂S on the surface of metal sulfides for Li—S batteries. Proc. Natl. Acad. Sci., U.S.A. 2017,114, 840.
[17]. B. Zhang, C. Luo, Y. Deng, Z. Huang, G. Zhou, W. Lv, Y. He, Y. Wan, F. Kang, Q. Yang, Optimized catalytic WS₂—WO₃ heterostructure design for accelerated polysulfide conversion in lithium-sulfur batteries. Adv. Energy Mater. 2020, 10, 2000091.
[18]. X. Tao, J. Wang, Z. Ying, Q. Cai, G. Zheng, Y. Gan, H. Huang, Y. Xia, C. Liang, W. Zhang, Y. Cui, Strong sulfur binding with conducting magnéli-phase TiₙO₂ₙ₋₁ nanomaterials for improving lithium-sulfur batteries. Nano Lett. 2014, 14, 5288.
[19]. J. Hwang, H. Kim, S. Lee, J. Lee, A. Abouimrane, M. A. Khaleel, I. Belharouak, A. Manthiram, High-energy, high-rate, lithium-sulfur batteries: synergetic effect of hollow TiO₂-webbed carbon nanotubes and a dual functional carbon-paper interplayer. Adv. Energy Mater. 2016, 6, 1501480.
[20]. T. Jeong, D. Choi, H. Song, J. Choi, S. Park, S. Oh, H. Kim, Y. Jung, Y. Kim, Heterogeneous catalysis for lithuim-sulfur batteries: enhanced rate performance by promoting polysulfide fragmentations. ACS Energy Lett. 2017, 2, 327.
[21]. Z. Li, Q. He, X. Xu, Y. Zhao, X. Liu, C. Zhou, D. Ai, L. Xia, L. Mai, A 3D nitrogen-doped graphene/TiN nanowires composite as a strong polysulfide anchor for lithium-sulfur batteries with enhanced rate performance and high areal capacity. Adv. Mater. 2018, 30, 201804089.
[22]. T. Zhou, W. Lv, J. Li, G. Zhou, Y. Zhao, S. Fan, B. Liu, B. Li, F. Kang, Q. Yang, Twinborn TiO₂—TiN heterostructures enabling smooth trapping-diffusion-conversion of polysulfides towards ultralong life lithium-sulfur batteries. Energy Environ. Sci. 2017, 10, 1694
[23]. S. Chung, L. Luo, A. Manthiram, TiS₂-polysulfide hybrid cathode with high sulfur loading and low electrolyte consumption for lithium-sulfur batteries. ACS Energy Lett. 2018, 3, 568.
[24]. C. Chang, A. Manthiram, Covalently grafted polysulfur-graphene nanocomposites for ultrahigh sulfur-loading lithium-polysulfur batteries. ACS Energy Lett. 2018, 3, 72.
[25]. Q. Pang, X. Liang, C. Kwok, J. Kulisch, L. Nazar, A comprehensive approach toward stable lithium-sulfur batteries with high volumetric energy density. Adv. Energy Mater. 2017, 7, 1601630.
[26]. M. Yu, J. Ma, M. Xie, H. Song, F. Tian, S. Xu, Y. Zhou, B. Li, D. Wu, H. Qiu, R. Wang, Freestanding and sandwich-structured electrode material with high areal mass loading for long-life lithium-sulfur batteries. Adv. Energy Mater. 2017, 7, 1602347.
[27]. M. Wang, L. Fan, X. Sun, B. Guan, B. Jiang, X. Wu, D. Tian, K. Sun, Y. Qiu, X. Yin, Y. Zhang, N. Zhang, Nitrogen-doped CoSe₂ as a bifunctional catalyst for high areal capacity ans lean electrolyte of Li—S battery. ACS Energy Lett. 2020, 5, 3041.
[28]. M. Li, R. Carter, A. Douglas, L. Oakes, C. L. Pint, Sulfur vapor-infiltrated 3D carbon nanotube foam for binder-free high areal capacity lithium-sulfur battery composite cathodes. ACS Nano 2017, 11, 4877.
[29]. Y. Zhang, Z. Zhang, S. Liu, G. Li, X. Gao, Free-standing porous carbon nanofiber/carbon nanotube film as sulfur immobilizer with high areal capacity for lithium-sulfur battery. ACS Appl. Mater. Interfaces 2018, 10, 8749.
[30]. S. Chung, A. Manthiram, Designing lithium-sulfur cells with practically necessary parameters. Joule 2018, 2, 710.
[31]. S. Chuang, C. Chang, A. Manthiram, A carbon-cotton cathode with ultrahigh-loading capability for statically and dynamically stable lithium-sulfur batteries. ACS Nano 2016, 10, 10462.
[32]. P. Ragupathy, S. A. Ahad, P. R. Kumar, H. W. Lee, D. K. Kim, A flexible glass fiber based freestanding composite electrode for high-performance lithium polysulfide batteries. Adv. Sustainable Syst 2017, 1, 1700083.
[33]. X. Peng, Y. Lu, L. Zhou, T. Sheng, S. Shen, H. Liao, L. Huang, J. Li, S. Sun, Graphitized porous carbon materials with high sulfur loading for lithium-sulfur batteries. Nano Energy 2017, 32, 503.
[34]. H. Peng, W. Xu, L. Zhu, D. Wang, J. Huang, X. Cheng, Z. Yuan, F. Wei, Q. Zhang, 3D carbonaceous current collectors: the origin of enabled cycling stability for high-sulfur-loading lithium-sulfur batteries. Adv. Funct. Mater. 2016, 26, 6351.
[35]. L. Qie, C. Zu, A. Manthiram, A high energy lithium-sulfur battery with ultrahigh-loading lithium polysulfide cathode and its failure mechanism. Adv. Energy Mater. 2016, 6, 1502459.
[36]. Y. Zhang, K. Li, H. Li, Y. Peng, Y. Wang, J. Wang, J. Zhao, High sulfur loading lithium-sulfur batteries based on a upper current collector electrode with lithium-ion conductive polymers. J. Mater. Chem. A 2017, 5, 97.
[37]. Y. Chen, S. Lu, J. Zhou, W. Qin, X. Wu, Synergistically assembled Li₂S/FWNTs@rdeuced graphene oxide nanobundle forest for free-standing high-performance Li₂S cathodes. Adv. Funct. Mater. 2017, 17, 1700987.

In the foregoing specification, implementations have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A battery comprising:
a sponge of carbon nanotubes; and
a heterostructure formed on the carbon nanotubes by atomic layer deposition followed by annealing.

2. The battery of claim 1, wherein the sponge of carbon nanotubes forms a cathode of the battery.

3. The battery of claim 2, wherein the battery further comprises a lithium foil anode, an ether-based electrolyte, a separator positioned between the anode and the carbon nanotubes cathode, and an ether-based electrolyte including lithium sulfide.

4. The battery of claim 3, wherein the electrolyte comprises Li₂S₆.

5. The battery of claim 1, wherein the heterostructure comprises a first compound and a second compound combined by:
depositing the first compound on the sponge;
depositing the second compound on the sponge; and
annealing the first compound and the second compound such that a distribution of the first compound and the second compound becomes more uniform than before the annealing.

6. The battery of claim 5, wherein the first compound is TiN and the second compound is TiO₂.

7. The battery of claim 6, wherein the first compound has a thickness of between 7 to 13 nm and the second compound has a thickness of between 3 and 7 nm.

8. The battery of claim 6, wherein the first compound has a thickness of between 8 and 12 nm and the second compound has a thickness of between 4 and 6 nm.

9. The battery of claim 6, wherein the first compound has a thickness of between 9 and 11 nm and the second compound has a thickness of between 4.5 and 5.5 nm.

10. The battery of claim 6, wherein the first compound has a thickness of 10 nm and the second compound has a thickness of 5 nm.

11. A method comprising:
fabricating a sponge of carbon nanotubes;
depositing a first layer of a first compound on the sponge;
depositing a second layer of a second compound over the first layer; and
performing annealing on the sponge, the first layer, and the second layer such that a distribution of the first compound and the second compound on the sponge becomes more uniform than before the annealing.

12. The method of claim 11, wherein depositing the first layer and depositing the second layer comprise performing atomic layer deposition.

13. The method of claim 11, wherein the first compound is TiN and the second compound is TiO₂.

14. The method of claim 13, wherein the first layer has a thickness of between 7 to 13 nm and the second layer has a thickness of between 3 and 7 nm.

15. The method of claim 13, wherein the first layer has a thickness of between 8 to 12 nm and the second layer has a thickness of between 4 and 6 nm.

16. The method of claim 13, wherein the first layer has a thickness of between 9 to 11 nm and the second layer has a thickness of between 4.5 and 5.5 nm.

17. The method of claim 13, wherein the first layer has a thickness of 10 nm and the second layer has a thickness of 5 nm.

18. The method of claim 11, further comprising, assembling a battery comprising, the sponge following the annealing, a separator, a lithium foil anode, an ether-based electrolyte and an ether-based electrolyte including lithium sulfide.

19. The method of claim 18, wherein the lithium sulfide comprises Li₂S₆.

20. The method of claim 11, wherein performing the annealing comprises annealing at a heating rate of 8 to 12° C. min⁻¹ to a final temperature of 600 to 700° C. in a nitrogen environment.
